(19) United States
(12) Patent Application Publication
(10) Pub. No.: US 2014/0099568 A1
(43) Pub. Date: Apr. 10, 2014

(54) CATALYST FOR FUEL CELL, METHOD OF PREPARING SAME, MEMBRANE-ELECTRODE ASSEMBLY AND FUEL CELL SYSTEM INCLUDING SAME

(71) Applicant: SAMSUNG SDI CO., LTD., Yongin-si (KR)

(72) Inventors: Myoung-Ki Min, Yongin-si (KR); Yong-Bum Park, Yongin-si (KR); Sung-Chul Lee, Yongin-si (KR); Jun-Young Kim, Yongin-si (KR); Hee-Tak Kim, Yongin-si (KR)

(73) Assignee: Samsung SDI Co., Ltd., Yongin-si (KR)

(21) Appl. No.: 13/827,172

(22) Filed: Mar. 14, 2013

(30) Foreign Application Priority Data
Oct. 9, 2012 (KR) 10-2012-0112026

(51) Int. Cl. H01M 4/86; H01M 4/88; H01M 8/10

(52) U.S. Cl. CPC H01M 4/8663; H01M 4/8657; H01M 8/1018; H01M 4/88
USPC 429/487; 429/523; 429/524; 429/526; 429/527; 429/535

(57) ABSTRACT

Disclosed are a catalyst for a fuel cell, a method of preparing the same, and an electrode for a fuel cell, a membrane-electrode assembly for a fuel cell, and a fuel cell system including the same, and the catalyst includes a carrier; and an active metal supported on the carrier, wherein the carrier is crystalline carbon bonded with a functional group represented by the following Chemical Formula 1 at the surface thereof.

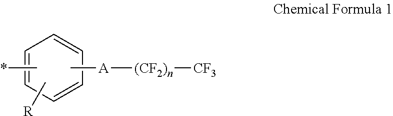

In Chemical Formula 1, each substituent is the same as described in the detailed description.

### CROSS-REFERENCE TO RELATED APPLICATIONS

This application claims priority to and the benefit of Korean Patent Application No. 10-2012-0112026 filed in the Korean Intellectual Property Office on Oct. 9, 2012, the entire contents of which are incorporated herein by reference.

### BACKGROUND

1. Field

This disclosure relates to a catalyst for a fuel cell, a method of preparing the same, and a membrane-electrode assembly for a fuel cell, and a fuel cell system including the same.

2. Description of the Related Technology

A fuel cell is a power generation system for producing electrical energy through an electrochemical redox reaction of an oxidant and hydrogen included in a hydrocarbon-based material such as methanol, ethanol, natural gas, and the like.

Such a fuel cell is a clean energy source that can replace fossil fuels. It includes a stack composed of unit cells and has an advantage of producing various ranges of power. Since it has a four to ten times higher energy density than a small lithium battery, it has been high-lighted as a small portable power source.

Typical examples of a fuel cell are a polymer electrolyte membrane fuel cell (PEMFC) and a direct oxidation fuel cell (DOFC). A direct oxidation fuel cell which uses methanol as a fuel is called to be a direct methanol fuel cell (DMFC).

The polymer electrolyte fuel cell has an advantage of having high energy density and power, but also, a problem of carefully handling of the hydrogen gas, and requiring accessory facilities such as a fuel-reforming processor for reforming fuel gas such as methane, methanol, and natural gas in order to produce hydrogen.

In contrast, the direct oxidation fuel cell has a lower energy density than the polymer electrolyte fuel cell but an advantage of easy handling of liquid-type fuel, being operated at a low temperature, and requiring no additional fuel reforming processor.

In the above fuel cell, the stack that actually generates electricity includes several to scores of unit cells stacked in multi-layers. Each unit cell is made up of a membrane-electrode assembly (MEA) and a separator (also referred to as a bipolar plate). The membrane-electrode assembly has an anode (referred to as a fuel electrode or an oxidation electrode) and a cathode (referred to as an air electrode or a reduction electrode) attached to each other with an electrolyte membrane therebetween.

Fuel is supplied to an anode and adsorbed on catalysts of the anode and then oxidized to produce protons and electrons. The electrons are transferred into the anode, a reducing electrode, via an external circuit to the cathode, while the protons are transferred into the cathode through the polymer electrolyte membrane. In addition, an oxidant is supplied to the cathode. Then, the oxidant, protons, and electrons are reacted on catalysts of the cathode to produce electricity along with water.

### SUMMARY

An exemplary embodiment provides a catalyst for a fuel cell having improved stability and excellent catalyst performance.

Another embodiment provides a method of preparing a catalyst for a fuel cell.

Yet another embodiment provides a membrane-electrode assembly for a fuel cell including the catalyst for a fuel cell.

Still another embodiment provides a fuel cell system including the membrane-electrode assembly.

According to an embodiment, provided herein is a catalyst for a fuel cell that includes a carrier; and an active metal supported on the carrier, wherein the carrier is crystalline carbon bonded with a functional group represented by the following Chemical Formula 1 at the surface thereof.

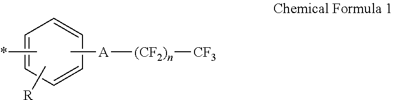

In Chemical Formula 1,

A may be a single bond or a heterocycle, provided when A is a single bond, n is 0 to 3, and when A is heterocycle, n is 0,

the heterocycle is an N-containing 5-membered ring or 6-membered ring, and

R may be hydrogen, F (fluorine), NH₂, SH, CN, COOH, SO₃H, CF₃, or NO₂.

The crystalline carbon may have a Raman spectrum intensity ratio of (1360) plane and (1580) plane, G/D((I(1580 cm⁻¹)/I(1360 cm⁻¹)), of greater than or equal to about 0.7.

The carrier may have a specific surface area of about 50 m²/g to about 800 m²/g.

The active metal may be platinum, ruthenium, osmium, a platinum-ruthenium alloy, a platinum-osmium alloy, a platinum-palladium alloy, a platinum-M alloy (M is at least one transition element selected from Ga, Ti, V, Cr, Mn, Fe, Co, Ni, Cu, Zn, Sn, Mo, W, Rh, and Ru), or a combination thereof.

According to another embodiment, a method of preparing a catalyst for a fuel cell that includes mixing an aromatic amine compound with a catalyst material including crystalline carbon and an active metal or crystalline carbon in a solvent to obtain a mixture; adding NaNO₂ and HCl to the mixture; and agitating the mixture; and drying the agitated product.

The crystalline carbon may be obtained by heat treating a carbon-based material at a temperature of about 1700° C. to about 3000° C.

The aromatic amine compound may be a compound represented by the following Chemical Formula 2.

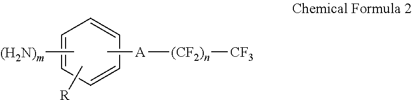

In Chemical Formula 2,

A may be a single bond or a heterocycle, provided when A is a single bond, n is 1 to 3, and when A is heterocycle, n is 0,

the heterocycle is an N-containing 5-membered ring or 6-membered ring,

R may be hydrogen, F, NH₂, SH, CN, COOH, SO₃H, CF₃, or NO₂, and

m may be 1 or 2, provided when n is 3, m is 1.

The catalyst material or the crystalline carbon, and aromatic amine compound may be mixed in a weight ratio of about 25:1 to about 1.24:1.

In the method of preparing the catalyst according to one embodiment, the agitating may be performed at about 50 rpm to about 500 rpm and at about 0° C. to about 30° C.

According to yet another embodiment, provided is an electrode for a fuel cell that includes an electrode substrate; and a catalyst layer disposed on the electrode substrate, wherein the catalyst layer includes the catalyst described above. According to still another embodiment, provided herein is a membrane-electrode assembly for a fuel cell that includes a cathode and an anode facing each other; and a polymer electrolyte layer between the cathode and anode, wherein at least one of the cathode and anode is the electrode described above.

According to still another embodiment, provided a fuel cell system that includes at least one electricity generating element including the membrane-electrode assembly described above and a separator positioned at each side of the membrane-electrode assembly, a fuel supplier and an oxidant supplier. The electricity generating element generates electricity through oxidation of a fuel and reduction of an oxidant. The fuel supplier plays the role of supplying the electricity generating element with a fuel. The oxidant supplier plays a role of supplying the electricity generating element with an oxidant.

The catalyst for a fuel cell according to one embodiment has excellent stability and performance.

### BRIEF DESCRIPTION OF THE DRAWINGS

FIG. 1 is a schematic view showing a fuel cell system according to one of the embodiments of the present disclosure.

FIG. 2 is a graph showing Raman spectrum intensity ratio (area ratio), G/D ((I(1580 cm⁻¹)/I(1360 cm⁻¹)) of the heated products according to Preparation Examples 1 to 4 and the unheated carbon-based material.

FIG. 3 is a XRD spectrum of catalyst according to Example 1 using CuKα.

FIG. 4 is a TEM photograph of catalyst according to Example 1.

FIG. 5 is a graph showing the stability of catalysts according to Examples 1 to 4 and Comparative Examples 1 to 6.

FIG. 6 is a graph showing the cyclic voltammogram of the catalyst according to Comparative Example 6 for 1000 voltage cycling in the accelerated cycle-life test.

FIG. 7 is a graph showing the cyclic voltammogram of the catalyst according to Example 2 for 1000 voltage cyclings in the accelerated cycle-life test.

FIG. 8 is a graph showing the cyclic voltammogram line of the catalyst according to Example 3 for 1000 voltage cyclings in the accelerated cycle-life test.

FIG. 9 is a graph showing the cyclic voltammogram of the catalyst according to Example 4 for 1000 voltage cyclings in the accelerated cycle-life test.

FIG. 10 is a graph showing the cyclic voltammogram of the catalyst according to Comparative Example 1 for 1000 voltage cycling in the accelerated cycle-life test.

FIG. 11 is a graph showing the cyclic voltammogram of the catalyst according to Comparative Example 2 for 1000 voltage cyclings in the accelerated cycle-life test.

FIG. 12 is a graph showing the activity of catalysts according to Comparative Example 11 (commercial catalyst (Pt/F)) and Examples 3 to 4 before and after the accelerated cycle-life test.

FIG. 13 is a graph showing the double layered current of electrodes according to Examples 1 to 4 and Comparative Examples 1 to 6.

### DETAILED DESCRIPTION

One present embodiment provides a catalyst for a fuel cell including a carrier and an active metal supported on the carrier, wherein the carrier is crystalline carbon bonded with a functional group represented by the following Chemical Formula 1 at the surface thereof.

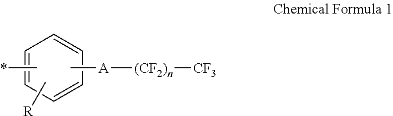

In Chemical Formula 1, A may be a single bond or heterocycle.

In addition, n is an integer of 0 to 3, and may be changed depending on A. That is to say, when A is a single bond, n is an integer ranging from 0 to 3, and when A is a heterocycle, n is 0.

The heterocycle may be an N-containing 5-membered ring or 6-membered ring. One example of heterocycle may be imidazole.

The R may be hydrogen, F (fluorine), NH₂, SH, CN, COOH, SO₃H, CF₃, or NO₂.

In Chemical Formula 1, * indicates a site where crystalline carbon is bonded.

The carrier according to one embodiment is hydrophobic since —(CF₂)ₙ—CF₃ is present on the surface as illustrated in Chemical Formula 1. Accordingly, the carrier is rarely contacted with water (H₂O), so the oxidation may be prevented. If other functional groups except —(CF₂)ₙ—CF₃, for example, an acidic group such as —COOH, —SO₃H or —SH, a nitrile group or the like are present on the surface, the carrier surface becomes hydrophilic, so that the oxidation is occurred on the carrier surface (e.g., oxidation of carbon), so that the carrier is unstabilized. In addition, when a catalyst is supported in the carrier, the catalyst is delaminated from the carrier and coagulated, which is not suitable.

The carrier may have a specific surface area of about 50 m²/g to about 800 m²/g. Generally, when the carrier includes carbon having relatively wide specific surface area of about 400 m²/g to about 800 m²/g, the active metal is easily supported, but the carbon oxidation characteristics often deteriorated, so it infrequently used to be applied for a carrier. However, in the carrier according to one embodiment, the hydrophobic group, represented by Chemical Formula 1, bonded with the carrier surface may suppress the approach of water, and thus, carbon corrosion may be prevented. Thereby, the carbon having the specific surface area of up to about 800 m²/g may be used as a carrier. When the carrier has a specific surface area of greater than about 800 m²/g, the functional group represented by Chemical Formula 1 is too insufficiently bonded to show hydrophobicity. Thus, the functional group represented by Formula 1 may be not used as a carrier when the specific surfaces area is greater than 800 m²/g.

In addition, the carrier according to the present invention is bonded with the functional group represented by Chemical Formula 1 on the surface thereof, so catalysts are supported between the active metals even if the specific surface area is decreased, so as to more improve the stability than the carbon having no functional group.

When the carrier has a specific surface area of less than about 50 m²/g, the surface area available for supporting the active metal of catalyst may be too small, so the functional group represented by Chemical Formula 1 bonded should not be used.

The crystalline carbon may have a Raman spectrum intensity ratio of (1360) plane and (1580) plane, G/D((I (1580 cm⁻¹)/I (1360 cm⁻¹)) of greater than or equal to about 0.7, and specifically about 0.7 to about 4.0.

When the crystalline carbon for the carrier has a Raman spectrum intensity ratio of less than about 0.7, the reaction with aromatic amine compound, which is a diazonium reaction, rarely occurs; and the functional group represented by Chemical Formula 1 is insufficiently bonded on the entire surface of carrier, so that the stability of carrier is not improved. Thus, the carrier surface is hydrophilic, the oxidation of carrier surface is occurred, which is not suitable. Alternatively, the carrier surface is partially hydrophilic, so the region that is hydrophilic is oxidized, thus minimizes the stability of carrier, which is not suitable.

When carbon for a carrier is crystalline carbon, the oxidation (corrosion) of the carbon carrier may be suppressed when the fuel cell goes through the on-off cycle or when the cathode voltage is increased in the fuel depletion by the fuel overflow in a membrane-electrode assembly. Accordingly, it may prevent the problems that the carbon carrier is depleted in the catalyst due to the corrosion, in which case the carbon carrier is converted into CO₂, so while the active metals supported on the carrier are depleted or aggregated, resulting in the deterioration of the structure of catalyst layer and thus the deterioration of the fuel cell performance.

When carbon for the carrier is not crystalline but amorphous, an aromatic amine compound may not be or insufficiently bound therewith, resulting in undesirable oxidation (corrosion) of the carrier.

The active metal may include platinum, ruthenium, osmium, a platinum-ruthenium alloy, a platinum-osmium alloy, a platinum-palladium alloy, a platinum-M alloy (M is at least one transition element selected from Ga, Ti, V, Cr, Mn, Fe, Co, Ni, Cu, Zn, Sn, Mo, W, Rh, and Ru), or a combination thereof. The catalyst according to one embodiment may be used in an anode and/or a cathode. The anode and cathode may include the same catalyst. However, a direct oxidation fuel cell may include a platinum-ruthenium alloy catalyst as an anode catalyst in order to prevent catalyst poisoning due to CO generated during the anode reaction. Specific examples may include one selected from Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, and Pt/Ru/Sn/W. More specific example of the active metal may be a Pt—Co alloy.

The catalyst according to one embodiment may be prepared according to the following processes.

A catalyst material including crystalline carbon and an active metal or crystalline carbon, is mixed with an aromatic amine compound in a solvent.

The solvent may be water, alcohol, or a mixture thereof. The alcohol may be methanol, ethanol, propanol, or a mixture thereof. To provide the solvent, water and alcohol may be mixed at a volume ratio of about 5:95 to about 50:50.

The crystalline carbon may a material obtained by heat treating a carbon-based material at a temperature of about 1700° C. to about 3000° C. Through the heat treatment, carbon having high crystallinity, particularly carbon having a Raman spectrum intensity ratio of (1360) plane and (1580) plane, G/D((I (1580 cm⁻¹)/I (1360 cm⁻¹)) of greater than or equal to about 0.7, specifically about 0.7 to about 4.0, may be prepared.

Through the heat treatment, crystalline carbon having a specific surface area of about 50 m²/g to about 800 m²/g may be prepared.

The carbon-based material may be any carbon-based material, and examples may be denka black, ketjen black, acetylene black, carbon nanotube, a carbon nano fiber, carbon nano wire, carbon nano ball, activated carbon, grapheme, or a combination thereof.

The aromatic amine compound may be a compound represented by the following Chemical Formula 2.

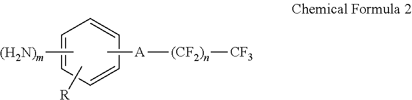

In Chemical Formula 2, A may be a single bond or a heterocycle.

In addition, n may be an integer of 0 to 3, and may be changed depending on A. That is to say, when A is a single bond, n is an integer ranging from 0 to 3, and when A is a heterocycle, n is 0.

The heterocycle is an N-containing 5-membered ring or 6-membered ring, and one example of heterocycle may be imidazole.

The R may be hydrogen, F, NH₂, SH, CN, COOH, 50₃H, CF₃, or NO₂.

In Chemical Formula 2 m is 1 or 2, provided that when n is 3, m is 1.

The catalyst material or the crystalline carbon and aromatic amine compound may be mixed in a weight ratio of about 25:1 to about 1.24:1. When the catalyst material or the crystalline carbon, and the aromatic amine compound are mixed within this range, the functional group of Chemical Formula 1 may be bonded with the carrier in an appropriate amount to increase hydrophobicity of catalyst.

Then NaNO₂ and HCl are added to the mixture. The NaNO₂ may be added in about 2 mol to about 3 mol based on 1 mol of the aromatic amine compound.

In addition, HCl may be appropriately included in about 500 μl to about 50 ml

The process of adding NaNO₂ and HCl may be performed by adding NaNO₂, first and agitating the same and then adding HCl; or adding HCl first, and agitating the same and then adding NaNO₂. In addition, NaNO₂ and HCl may be added together, so the adding order does not significantly affect on the resultant diazonium reaction.

The resultant mixture is agitated. The agitation may be performed at a speed of about 50 rpm to about 500 rpm. When the agitation is performed within the speed range, the crystalline carbon or the catalyst material may be appropriately dispersed to perform the uniform diazonium reaction on the carrier surface. In addition, the agitation may be performed at about 0° C. to about 30° C.

According to the agitation, the diazonium reaction is occurred. For the diazonium reaction mechanism, the case of using 3-aminobenzotrifluoride as an amine compound is exemplified and illustrated by the following Reaction Scheme 1.

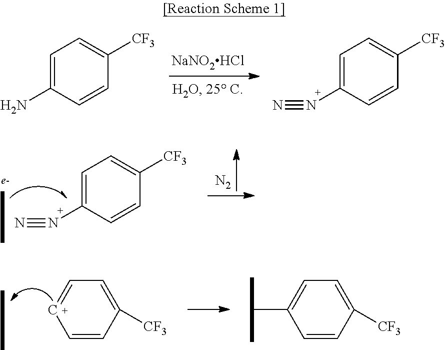

In the other words, as shown in Reaction Scheme 1, in 3-aminobenzotrifluoride, amine group is converted to diazonium group; and in the crystalline carbon, N₂ is removed from the crystalline carbon a the electron donor reaction to bond the trifluoromethylphenyl group to the crystalline carbon surface.

The following Reaction Scheme 2 illustrates the phenomenon that the functional group represented by Chemical Formula 1 is bonded with the catalyst material including active metal supported in the crystalline carbon carrier with the amine compound, for example, 6-aminoindazole for the amine compound.

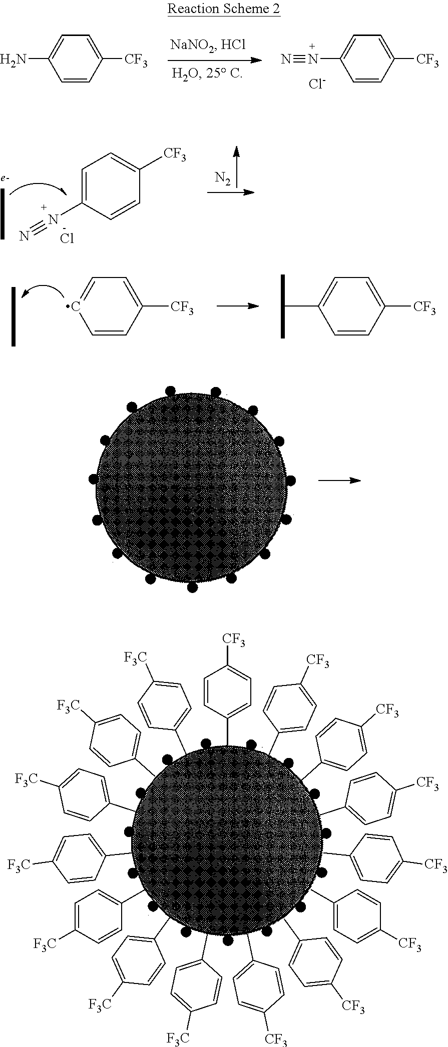

As shown in Reaction Scheme 2, the functional group represented by Chemical Formula 1 is bonded on the surface of crystalline carbon carrier.

The agitated product is dried. The drying may be performed for about 1 hour to 12 hours. In addition, before the drying, the further processing such as filtering and washing or the like may be further performed. The washing may be performed with water, methanol, acetone, tetrahydrofuran, methyl acetate or the like.

Another of the present embodiments provides an electrode for a fuel cell including a catalyst layer including the catalyst described above and an electrode substrate.

The catalyst layer may further include a binder resin to improve its adherence and proton transfer properties.

The binder resin may be a proton conductive polymer resin. Examples of the binder resin may include a polymer resin having a cation exchange group selected from a sulfonic acid group, a carboxylic acid group, a phosphoric acid group, a phosphonic acid group, and derivatives thereof at its side chain. Examples of the polymer resin may include at least one proton conductive polymer selected from a fluoro- polymer, a benzimidazole- polymer, a polyimide- polymer, a polyetherimide- polymer, a polyphenylenesulfide- polymer, a polysulfone- polymer, a polyethersulfone- polymer, a polyetherketone- polymer, a polyether-etherketone- polymer, and a polyphenylquinoxaline- polymer. More specific examples of the binder resin may include at least one proton conductive polymer selected from poly(perfluorosulfonic acid), poly(perfluorocarboxylic acid), a tetrafluoroethylene coploymer having a sulfonic acid group and a fluorovinylether group, polyetherketone sulfide, aryl ketone, poly (2,2′-m-phenylene)-5,5′-bibenzimidazole, or poly (2,5-benzimidazole).

The hydrogen (H) ion in the cation exchange group of the proton conductive polymer can be substituted with Na, K, Li, Cs, or tetrabutylammonium ions. When the H ion in the cation exchange group of the terminal end of the proton conductive polymer side chain is replaced with Na or tetrabutylammonium ions, NaOH or tetrabutylammonium hydroxide may be used during preparation of the catalyst composition, respectively. When the H ions are replaced with K, Li, or Cs ions, suitable compounds for the replacement reactions may be used.

The binder resin may be used singularly or in combination. They may be used along with non-conductive polymers to improve adherence with a polymer electrolyte membrane.

Examples of the non-conductive polymers include at least one selected from polytetrafluoroethylene (PTFE), tetrafluoroethylene-hexafluoropropylene copolymer (FEP), tetrafluoroethylene-perfluoroalkylvinylether copolymer (PFA), ethylene/tetrafluoroethylene (ETFE), ethylenechiorotrifluoro-ethylene copolymer (ECTFE), polyvinylidenefluoride, a polyvinylidenefluoride-hexafluoropropylene copolymer (PVdF-HFP), dodecylbenzenesulfonic acid, and sorbitol.

The electrode substrate plays a role of supporting an electrode and diffusing fuel and an oxidant into a catalyst layer, so that the fuel and the oxidant can easily approach the catalyst layer

In one embodiment, the electrode substrates are formed from a material such as carbon paper, carbon cloth, carbon felt, or a metal cloth (a porous film composed of metal fiber or a metal film disposed on a surface of a cloth composed of polymer fibers). The electrode substrate is not limited thereto.

The electrode substrates may be treated with a flurocarbon resin in order to be water-repellent and thus prevent deterioration of diffusion efficiency due to water generated during operation of a fuel cell. The fluorine-based resin may be one selected from polytetrafluoroethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, and a copolymer thereof.

tTo increase reactant diffusion effects between the electrode substrates and catalyst layer, the anode or cathode may further include a microporous layer on an electrode substrate. The microporous layer generally includes conductive powders with a certain particle diameter. The conductive material may include, but is not limited to, carbon powder, carbon black, acetylene black, activated carbon, a carbon fiber, fullerene, carbon nanotubes, carbon nanowires, carbon nanohorns, carbon nanorings, or combinations thereof.

The microporous layer is formed by coating a composition comprising a conductive powder, a binder resin, and a solvent on the conductive substrate. The binder resin may include, but is not limited to, polytetrafluoroethylene, polyvinylidenefluoride, polyhexafluoropropylene, polyperfluoroalkylvinylether, polyperfluorosulfonylfluoride, alkoxyvinyl ether, polyvinylalcohol, cellulose acetate, or copolymers thereof. The solvent may include, but is not limited to, an alcohol such as ethanol, isopropyl alcohol, n-propyl alcohol, butanol, and so on, water, dimethyl acetamide, dimethyl sulfoxide, N-methylpyrrolidone, or tetrahydrofuran. The coating method may include, but is not limited to, screen printing, spray coating, doctor blade methods, gravure coating, dip coating, silk screening, painting, and so on, depending on the viscosity of the composition.

According to another embodiment, a membrane-electrode assembly for a fuel cell including the electrode as either a cathode or an anode is provided. The membrane-electrode assembly for a fuel cell includes a cathode and an anode facing each other, and a polymer electrolyte membrane interposed between the cathode and anode.

The polymer electrolyte membrane may be any generally-used polymer electrolyte membrane made of a proton conductive polymer resin. The proton conductive polymer resin may be a polymer resin having a cation exchange group selected from the group consisting of a sulfonic acid group, a carboxylic acid group, a phosphoric acid group, a phosphonic acid group, and derivatives thereof, at its side chain.

Examples of the polymer resin include at least one selected from a fluorocarbon polymer, a benzimidazole- polymer, a polyimide- polymer, a polyetherimide- polymer, a polyphenylenesulfide- polymer, a polysulfone- polymer, a polyethersulfone- polymer, a polyetherketone- polymer, a polyether-etherketone- polymer, and a polyphenylquinoxaline- polymer. In addition, the polymer resin may include poly(perfluorosulfonic acid) (commercially available as “NAFION”, Dupont, Wilmington, Del.), poly(perfluorocarboxylic acid), a copolymer of tetrafluoroethylene having a sulfonic acid group and fluorovinylether, defluorinated polyetherketone sulfide, an aryl ketone, and poly [(2,2′-m-phenylene)-5,5′-bibenzimidazole].

The hydrogen (H) ion in the proton conductive group of the proton conductive polymer may be replaced by Na, K, Li, Cs, or tetrabutylammonium ions. When the H ion of a proton conductive group of a proton conductive polymer is replaced with Na ion, NaOH may be used, and when the H ion is replaced by tetrabutylammonium ion, tetrabutylammonium hydroxide may be used. When the H is replaced by K, Li, or Cs, suitable compounds for the substitutions may be used. Since such a replacement reaction is known to this art. Such Na, K, Li, Cs ions, or tetrabutylammonium ions may be replaced by protons during a subsequent acid treatment of a catalyst layer and thus yielding a proton form (H⁺-form) polymer electrolyte membrane.

Another embodiment provides a fuel cell system including at least one electricity generating element, a fuel supplier, and an oxidant supplier.

The electricity generating element includes the membrane-electrode assembly according to one embodiment and a separator (referred to as a bipolar plate). The electricity generating element plays a role of generating electricity through oxidation of a fuel and reduction of an oxidant.

The fuel supplier plays a role of supplying the electricity generating element with a fuel, while the oxidizing agent supplier plays a role of supplying the electricity generating element with an oxidizing agent such as oxygen or air.

In one embodiment, the fuel may include liquid or gaseous hydrogen or a hydrocarbon fuel. The hydrocarbon fuel, for example, includes methanol, ethanol, propanol, butanol, or natural gas.

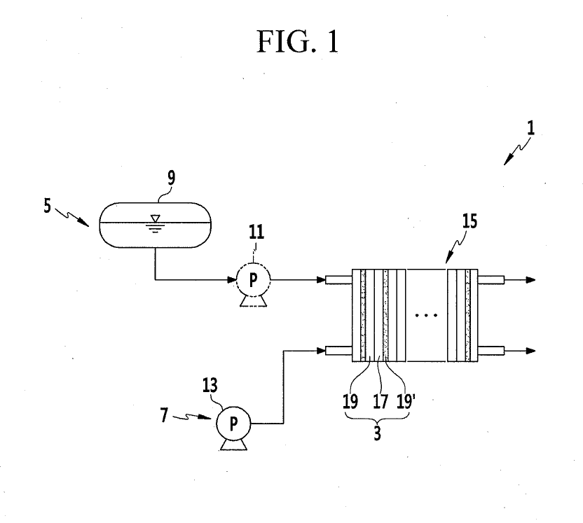

FIG. 1 shows the schematic structure of a fuel cell system according to one embodiment of the present invention, which will be described in details with the reference to this accompanying drawing as follows. FIG. 1 shows a fuel cell system supplying a fuel and an oxidizing agent to an electrical generating element using a pump, but the fuel cell system according to the embodiment is not limited to such structures. The fuel cell system of the embodiment alternately includes a structure wherein a fuel and an oxidant are provided in a diffusion manner.

A fuel system 1 of the embodiment includes at least one electricity generating element 3 which generates an electrical energy by oxidation of a fuel and reduction of an oxidizing agent, a fuel supplier 5 for supplying the fuel, and an oxidant supplier 7 for supplying oxidant to the electricity generating element 3.

In addition, the fuel supplier 5 is equipped with a tank 9, which stores fuel, and a pump 11, which is connected therewith. The fuel pump 11 supplies fuel stored in the tank 9 with a predetermined pumping power.

The oxidant supplier 7, which supplies the electricity generating element 3 with an oxidant, is equipped with at least one oxidant pump 13 for supplying an oxidant with a predetermined pumping power.

The electricity generating element 3 includes a membrane-electrode assembly 17, which oxidizes hydrogen or a fuel and reduces an oxidant, and separators 19 and 19′ that are respectively positioned at opposite sides of the membrane-electrode assembly and that supply hydrogen or a fuel, and an oxidant, respectively. The stack 15 is provided stacking at least one of the electricity generating elements 3.

The following examples illustrate the present disclosure in more detail. However, it is understood that the disclosure is not limited by these examples.

### Preparation Example 1

Ketjen black (Trade Name: 600JD, Manufacturer: Mitsubishi Chemical, Osaka, Japan) was heated at 2500° C. for 3 hours. The heated product was measured for a BET specific surface area, and the result was 220 m²/g.

### Preparation Example 2

Ketjen black (Trade Name: 600JD, Manufacturer: Mitsubishi Chemical, Osaka, Japan) was heated at 2000° C. for 3 hours. The heated product was measured for a BET specific surface area, and the result was 450 m²/g.

Preparation Example 3

Ketjen black (Trade Name: 600JD, Manufacturer: Mitsubishi Chemical, Osaka, Japan) was heated at 1700° C. for 3 hours. The heated product was measured for a BET specific surface area, and the result was 800 m²/g.

### Preparation Example 4

Ketjen black (Trade Name: 600JD, Manufacturer: Mitsubishi Chemical, Osaka, Japan) was heated at 1500° C. for 3 hours. The heated product was measured for a BET specific surface area, and the result was 1050 m²/g.

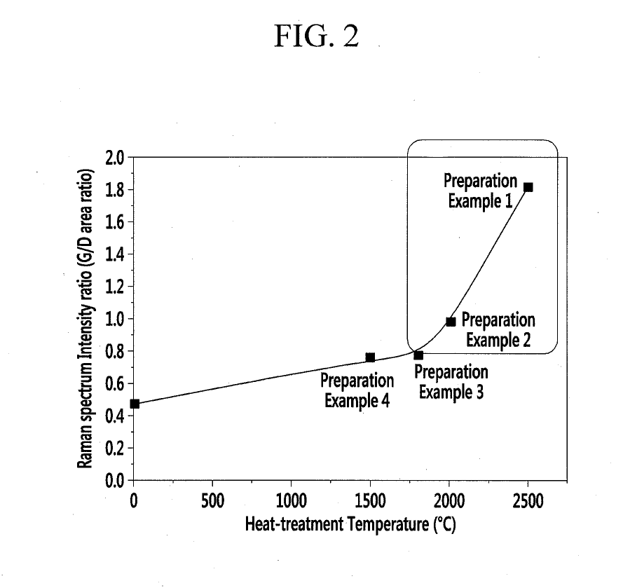

The (1360) plane and the (1580) plane of the heated product according to Preparation Examples 1 to 4 and the non-heated ketjen black (Trade name: 600JD, Manufacturer: Mitsubishi Chemical, BET specific surface area 1280 m²/g) were measured by Raman spectrum. The intensity ratio (integrated area ratio), G/D((I (1580 cm⁻¹)/I (1360 cm⁻¹)) were calculated from the Raman spectrum, and the results are shown in FIG. 2. As shown in FIG. 2, the heated products-from Preparation Examples 1 to 4 showed the Raman spectrum intensity ratio (integrated area ratio), G/D ((I (1580 cm⁻¹)/I (1360 cm⁻¹)) of about 1.8, 1.0, 0.8, 0.8, respectively, and the non-heated ketjen black was greater than 0.5. In particular, the products heated at 2500° C. and 2000° C. according to Preparation Examples 1 and 2 had high Raman spectrum intensity ratios (integrated area ratio).

### Example 1

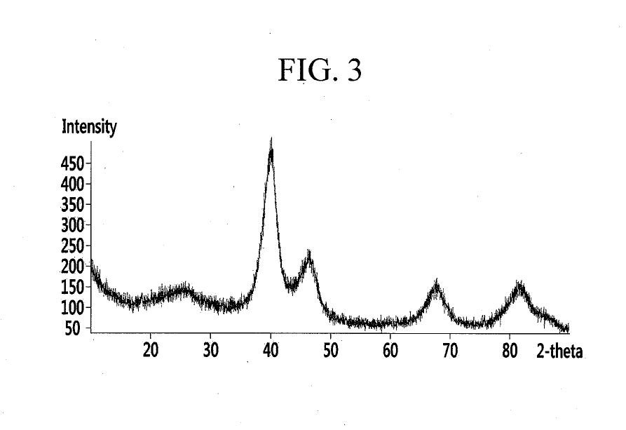

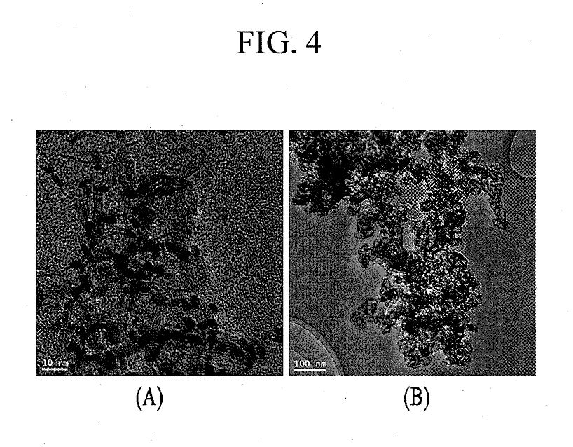

Platinum was supported in the heated crystalline carbon according to Preparation Example 2 using gamma-radiation to provide a catalyst material (supported amount: 42 wt %) consisting of platinum supported in crystalline carbon. The product thus obtained was measured using CuKα for a XRD spectrum and a TEM photograph, and the results are shown in FIG. 3 and FIG. 4, respectively.

Using the Pt (111) plane in which 2-theta was at 39.8 degrees in the XRD results of FIG. 3, the crystalline carbon particle size was calculated, and the result was about 3.2 nm.

In addition, the active metal was well dispersed in the crystalline carbon as shown in FIG. 4.

0.5 g of resultant product was dispersed in 100 ml of deionized water. The amine compound represented by the following Chemical Formula 3 was added to the dispersion at 0.08046 g (0.4 mmol), (weight ratio of the amine compound to the crystalline carbon carrier, weight ratio of amine compound: crystalline carbon carrier) and dispersed for 30 minutes.

NaNO₂ (0.0552 g, 0.8 mmol) was added to the resultant mixture and agitated at 300 rpm for 30 minutes. Aqueous HCl solution (0.5 ml, 0.5M) was then added thereto. The resultant mixture was agitated at 300 rpm at room temperature for 12 hours.

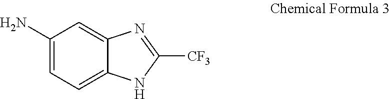 [SMILES: Nc1ccc2[nH]c(C(F)(F)F)nc2c1]

The agitated product was filtrated and sequentially washed with distilled water, methanol, and acetone and dried for 12 hours to provide a catalyst.

To the resultant catalyst (0.03 g), a Nafion® (Dupont, Wilmington, Del.) solution (500 ml) having a concentration of 0.5 wt % (10-time diluted solution, in that a mixed solvent of 5 wt % of Nafion®, 45 wt % of 1-propanol, and 50 wt % of 3-propanol was diluted in distilled water), and of isopropyl alcohol (4500 ml) were mixed to provide a catalyst composition. The mixing was performed by sonication for 20 minutes, and the general agitation was performed for 1 minute.

A portion of the catalyst composition (6 μl ) was coated on a glassy carbon electrode substrate having a diameter of 0.5 cm and the coated electrode was dried at a room temperature for 5 minutes. Nafion® solution (solvent: isopropyl alcohol, 7 μl ) having a concentration of 0.05 wt %, was dripped into the dried product and the resultant mixture was dried at room temperature for 10 minutes to provide an electrode. The catalyst loading amount in the electrode was about 85 μg/cm².

### Example 2

A catalyst was fabricated in accordance with the same procedure as in Example 1, and an electrode was fabricated using the catalyst, except that the amino compound was 0.071644 g (0.4 mmol) of the compound represented by the following Chemical Formula 4 (amine compound:crystalline carbon ratio=0.25:1).

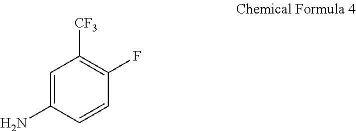 [SMILES: Nc1ccc(F)c(C(F)(F)F)c1]

### Example 3

A catalyst was fabricated in accordance with the same procedure as in Example 1, and an electrode was fabricated using the catalyst, except that the amine compound was 0.0824 g (0.4 mmol) of the compound represented by the following Chemical Formula 5 (amine compound:crystalline carbon ratio=0.28:1).

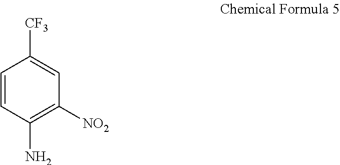 [SMILES: Nc1ccc(C(F)(F)F)cc1[N+](=O)[O-]]

### Example 4

A catalyst was fabricated in accordance with the same procedure as in Example 1, and an electrode was fabricated using the catalyst, except that the amine compound was 0.06445 g (0.4 mmol) of the compound represented by the following Chemical Formula 6 (amine compound:crystalline carbon ratio=0.22:1).

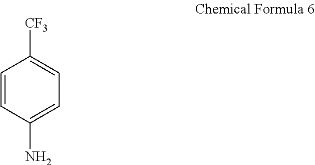 [SMILES: Nc1ccc(C(F)(F)F)cc1]

### Comparative Example 1

A catalyst was fabricated in accordance with the same procedure as in Example 1, and an electrode was fabricated using the catalyst, except that the amine compound was 0.06086 g (0.4 mmol) of the compound represented by the following Chemical Formula 7 (amine compound:crystalline carbon ratio=0.21:1).

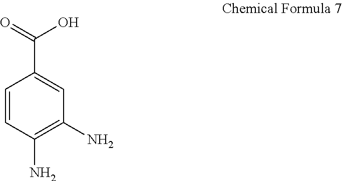 [SMILES: Nc1ccc(C(=O)O)cc1N]

### Comparative Example 2

A catalyst was fabricated in accordance with the same procedure as in Example 1, and an electrode was fabricated using a similar catalyst, except that the amine compound was 0.0893 g (0.4mmol) of the compound represented by the following Chemical Formula 8 (amine compound:crystalline carbon ratio=0.31:1).

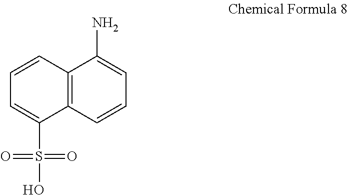 [SMILES: Nc1cccc2c(S(=O)(=O)O)cccc12]

### Comparative Example 3

A catalyst was fabricated in accordance with the same procedure as in Example 1, and an electrode was fabricated using a similar catalyst, except that the amine compound was 0.05726 g (0.4 mmol) of the compound represented by the following Chemical Formula 9 (amine compound:crystalline carbon ratio=0.20:1).

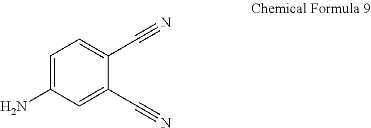 [SMILES: N#Cc1ccc(N)cc1C#N]

### Comparative Example 4

A catalyst was fabricated in accordance with the same procedure as in Example 1, and an electrode was fabricated using a similar catalyst, except that the amine compound was 0.047256 g (0.4 mmol) of the compound represented by the following Chemical Formula 10 (amine compound:crystalline carbon ratio=0.16:1).

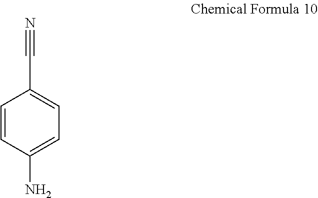

### Comparative Example 5

A catalyst was fabricated in accordance with the same procedure as in Example 1, and an electrode was fabricated using a similar catalyst, except that the amine compound was 0.050076 g (0.4 mmol) of the compound represented by the following Chemical Formula 11 (amine compound:crystalline carbon ratio=0.17:1).

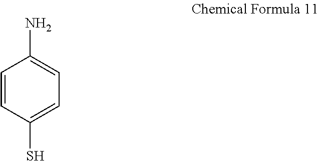

### Comparative Example 6

An electrode was fabricated in accordance with the same procedure as in Example 1, except that the catalyst (supported amount: 42 wt %) was prepared by supporting platinum in the heated crystalline carbon according to Preparation Example 2 using gamma-radiation.

### Comparative Example 7

Pt/C catalyst (0.5 g, supported amount: 45.6 wt %, TEC36F52, manufacturer: Tanaka Noble Metals, Tokyo, Japan) was dispersed in 100 ml of deionized water. The amine compound represented by the following Chemical Formula 3 (0.0805 g (0.4 mmol)), NaNO₂ (0.064 g (0.8 mmol)), and of aqueous HCl solution (0.5 ml, concentration: 0.5M) were added to the dispersion. The resultant mixture was agitated at 300 rpm at a room temperature for 12 hours.

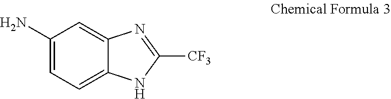 [SMILES: Nc1ccc2[nH]c(C(F)(F)F)nc2c1]

The resultant agitated product was filtered and sequentially washed with distilled water, methanol, and acetone and dried for 12 hours to provide a catalyst, and an electrode was fabricated using the catalyst.

### Comparative Example 8

The same procedure as in Comparative Example 6 was performed, except using a Pt/C catalyst (supported amount: 46 wt %, TEC36EA52, manufacturer: Tanaka Noble Metals, Tokyo, Japan).

### Comparative Example 9

Pt/C catalyst (0.5 g, supported amount: 45.6 wt %, TEC36F52, manufacturer: Tanaka Noble Metals, Tokyo, Japan) was dispersed in 100 ml of deionized water. The amine compound represented by Chemical Formula 3 (0.160916 g (0.8 mmol)), NaNO₂ (0.128 g (1.6 mmol)), and aqueous HC1 solution (1.0 ml, concentration: 0.5M) were added to the dispersion. The obtained mixture was agitated at 300 rpm at a room temperature for 12 hours.

### Comparative Example 10

The same procedure as in Comparative Example 9 was performed, except using a Pt/C catalyst (supported amount: 46 wt %, commercially available catalyst of TEC36EA52, manufacturer: Tanaka Noble Metals, Tokyo, Japan).

### Comparative Example 11

A Pt catalyst supported in F-type carbon with a specific surface area: about 800 m²/g (trade name: TEC10F50E, manufacturer: Tanaka Noble Metals, Tokyo, Japan, referring to Pt/F catalyst) was used.

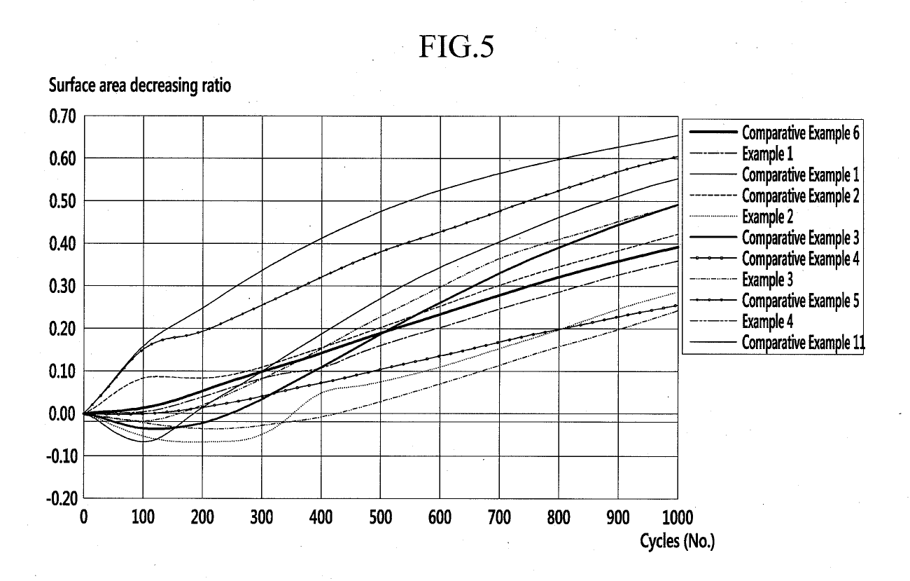

In order to evaluate the stability of catalysts obtained from Examples 1 to 4 and Comparative Examples 1 to 11, an accelerated cycle-life test was carried out. Using the electrodes from the above Examples and Comparative and the standard electrode of Ag/AgCl, an accelerated cycle-life test was performed under the conditions of repeating for 1000 cycles in CV (cyclic voltammetry) of between 0.6V and 1.4V based on the standard hydrogen potential under 0.1M of HClO₄ aqueous solution. Every 100 cycles, the electrochemical surface area was calculated during sweeping the scan rate of 20 mV/second, and the degradation was confirmed by the decreasing surface area of the catalyst. FIG. 5 shows the results of Examples 1 to 4, Comparative Examples 1 to 6, and Comparative Example 11. The surface area decreasing ratio means a ratio of (1-measured surface area/initial surface area).

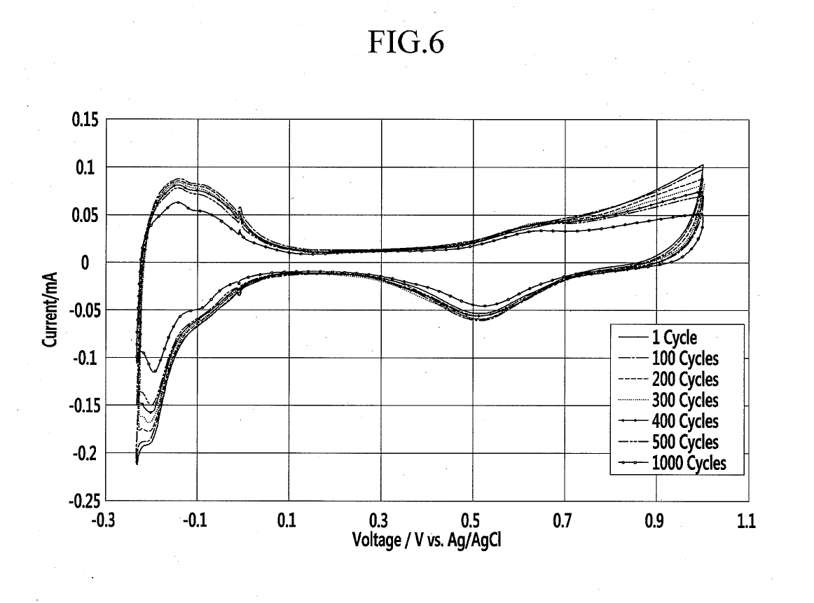

FIG. 5 shows the results obtained from the peak area at a region of −0.2V to 0.1V from the results of FIGS. 6 to 9.

As shown in FIG. 5, when the fuel cell was fabricated using the catalysts obtained from Examples 1 to 4, the stability were much improved compared to those of Comparative Examples 1 to 6. In addition, in Comparative Examples 7 and 8 the surface area deteriorated according to decreasing the stability when compared to the Pt/F catalyst.

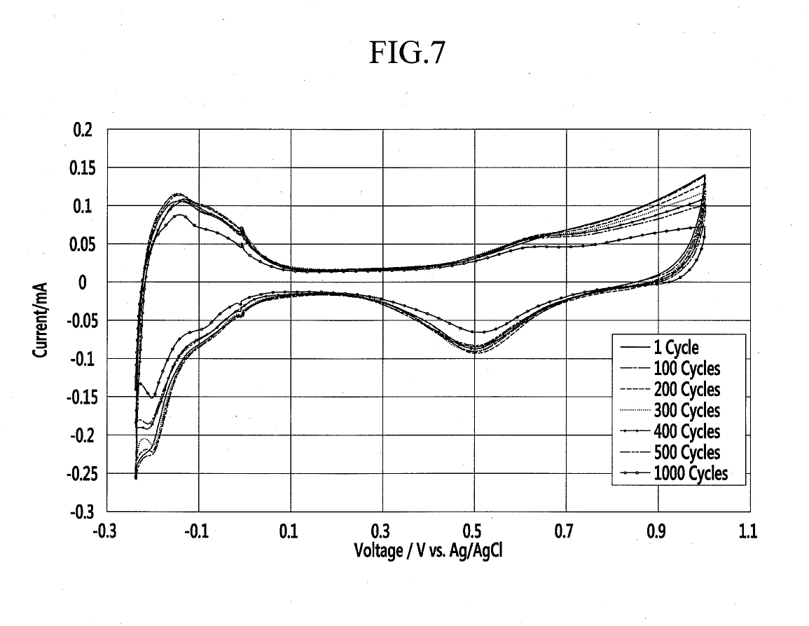

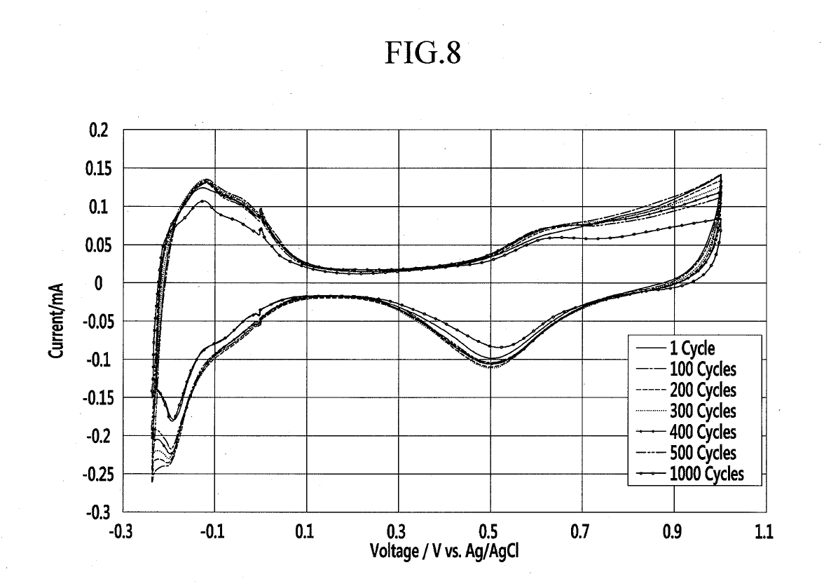

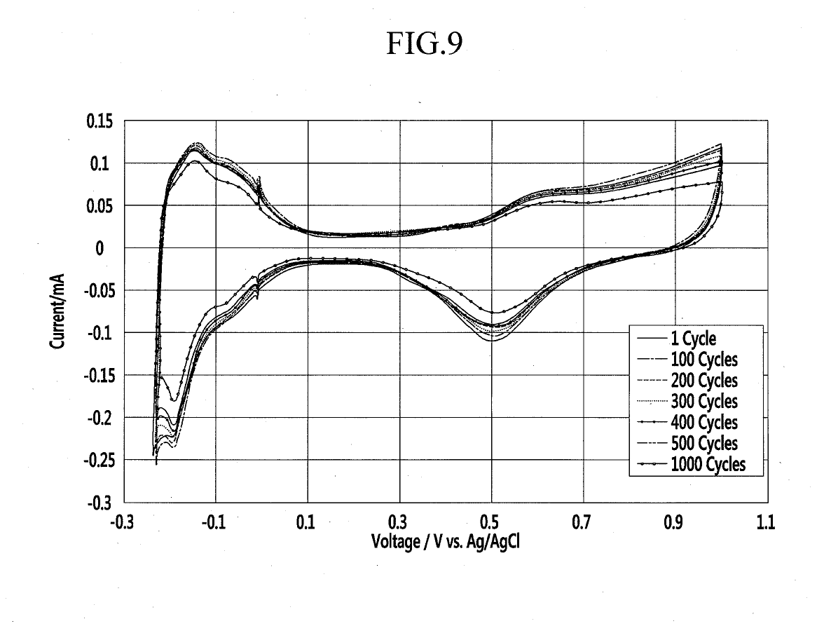

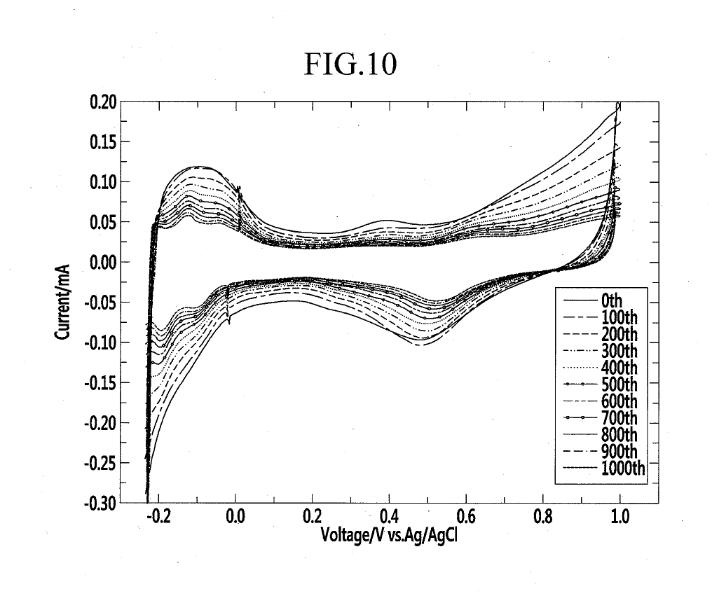

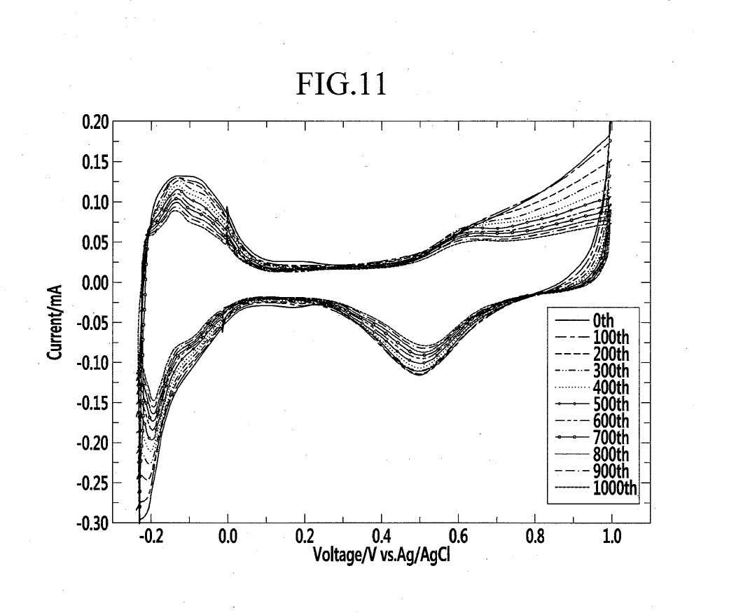

During the accelerated life-span test, a cyclic voltammogram was taken every 100 cycles of the charge-discharge cycle, and the results are shown in FIGS. 6 to 11, respectively. FIG. 6 shows a voltammogram of the catalyst of Comparative Example 6 that was not subjected to the diazonium reaction; FIG. 7 shows the cyclic voltammograms of Example 2; FIG. 8 shows the cyclic voltammograms of Example 3; FIG. 9 shows the cyclic voltammogram of Example 4; FIG. 10 shows the cyclic voltammogram of Comparative Example 1; and FIG. 11 shows the cyclic voltammogram of Comparative Example 2.

As shown in FIGS. 7 to 9, the surface area or the shape of active site were not different but similar to the results of catalyst of Comparative Example 6 shown in FIG. 6. Thus even if the functional group derived from the amine compound was partially bonded with the active metal using the diazonium reaction, it was all removed during the activation process after fabricating an electrode, so as to not affect the activity of the active metal.

Referring to FIGS. 7 to 9, the peak area at a region of −0.2V to 0.1V was less decreased when compared to the cyclic voltammogram of Comparative Example 6 set forth in FIG. 6. As shown in FIGS. 7 to 9, it is understood that the catalysts obtained from Examples 2 to 4 the surface area are less decreased in an amount of about 10% to 40% when compared to the same region of FIG. 6 for Comparative Example.

Referring to FIGS. 10 and 11, it is understood that the acidic group acted as a capacitor on the surface of carrier when the acidic group was bonded to the carrier surface, and it was delaminated from the carrier surface during the voltage cycling, so the platinum supported in the carrier was delaminated or coagulated, resulting in the surface area of catalyst being remarkably decreased. In FIGS. 10 and 11, the results at x-axis value (voltage/V vs. Ag/Agcl) of 0.2V to 0.4V indicates that the instability of the carbon carrier by acidic group. These results confirm that the stability of catalyst may be changed depending upon which functional group was present on the carbon surface.

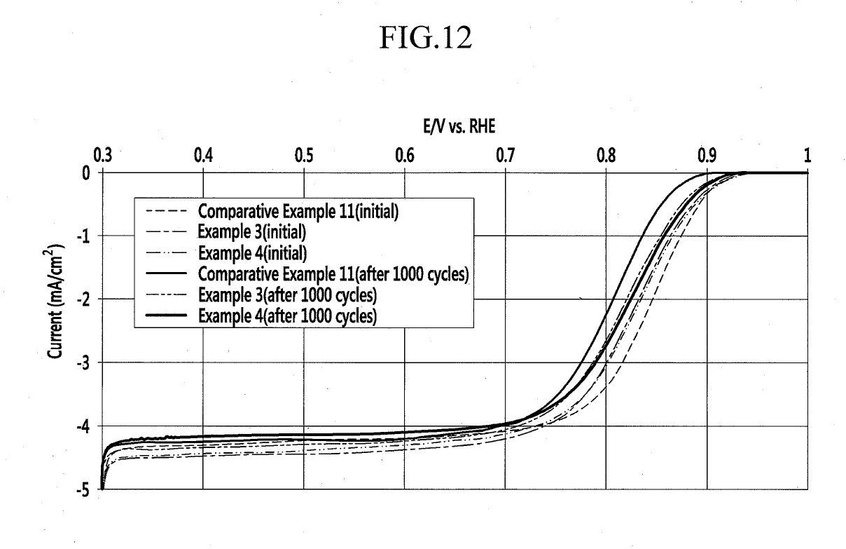

The catalyst (commercial catalyst Pt/F) used in Comparative Example 11 and the catalysts used in Examples 3 to 4 were measured for activity by the oxygen reduction reaction (ORR) test. The ORR test was carried out with a RDE (rotating disk electrode) and was performed at 25° C. and in an 0.1M HClO₄ aqueous solution, with a reference electrode of Ag/AgCl, a counter electrode of Pt, a scan rate of 5 mV/s, and a rotating rate of 400, 900, 1600, 2500 rpm. It was activated by CV cycling for 100 times between 0 V and 1.2V, and the measured current was set as the initial ORR current, and then CV was performed for 1000 cycles, and the final ORR current was measured. FIG. 12 shows the results at a rotating speed of 900 rpm (rotator: Corning PC620D model) As shown in FIG. 12, it is confirmed that the commercial catalyst (Pt/F) according to Comparative Example 11 had high initial ORR but remarkably decreased the activity after 1000 cycles. On the other hand, Examples 3 to 4 had less changed ORR even after 1000 cycles.

In the results of FIG. 12, current at 0.9 V and current at 0.85 V are shown in the following Table 1 and Table 2, respectively.

TABLE 1

| | Initial ORR current, | ORR current after | Decrease |
|---|---|---|---|
| | μA/cm² | 1000 cycles,μA/cm² | rate, % |
| Comparative | 387 | 16 | 96 |
| Example 11 | | | |
| (commercial | | | |
| catalyst Pt/F) | | | |
| Example 3 | 274 | 163 | 41 |
| Example 4 | 313 | 203 | 35 |

TABLE 2

| | Initial ORR current, | ORR current after | Decrease |
|---|---|---|---|
| | μA/cm² | 1000 cycles,μA/cm² | rate, % |
| Comparative | 1994 | 685 | 66 |
| Example 11 | | | |
| (commercial | | | |
| catalyst Pt/F) | | | |
| Example 3 | 1420 | 1098 | 23 |
| Example 4 | 1479 | 1206 | 18 |

As shown in Tables 1 and 2, it is understood that the initial current of commercial catalyst of Pt/F was higher than those of Examples 3 and 4; but after 1000 cycles, the current decrease rates of Examples 3 and 4 were remarkably less than that of commercial catalyst Pt/F.

The results demonstrate that the stability of catalyst was enhanced by the diazonium reaction to provide the relatively high ORR after 1000 cycles when compared to the initial ORR. It is estimated that the stability of catalyst was caused by the increased stability of carbon carrier. In other words, the catalyst stability is determined by the stability of ORR activity.

The stability may also be confirmed by how the double layered current of electrode is decreased.

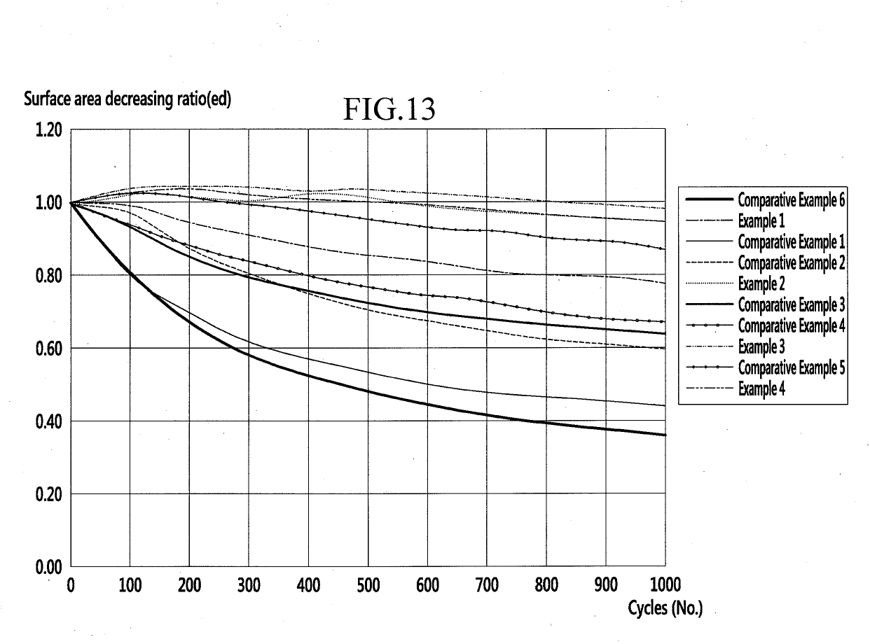

During a CV test, the oxidation/reduction due to platinum did not occur, the double layer providing a capacitor value by the carbon surface area provides information about the surface area of carbon. In other words, when the carbon is corroded by the oxidation, the amorphous carbon surface is decreased, which is reflected in the decrease of double layer current value. Each electrode obtained using the catalysts of Examples 1 to 4 and Comparative Examples 1 to 9 was measured for the double-layered current from the voltammogram shown in FIGS. 6 to 11, and the results are shown in FIG. 13. The double-layered current may be measured from current difference of the region where the electrochemical reaction did not occur in 0.1-0.3V (vs. Ag/AgCl) in the voltammogram shown in FIGS. 6 to 11. As shown in FIG. 13, it can be seen that the double-layered current decrease rates of catalysts obtained from Examples 2 to 4 were less than those of Comparative Examples 1 to 8. In addition, Example 1 had a somewhat high double-layered current decrease rate but maintained the almost uniform decreased level, so it was relatively stable compared to Comparative Examples 1 to 8.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A catalyst for a fuel cell, comprising:
a carrier; and an active metal supported on the carrier,
wherein the carrier is crystalline carbon bonded with a functional group represented by the following Chemical Formula 1 at the surface thereof, 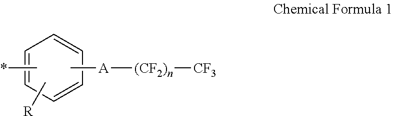
wherein:
A is a single bond or a heterocycle, provided when A is a single bond, n is 0 to 3, and when A is heterocycle, n is 0,
the heterocycle is an N-containing 5-membered ring or 6-membered ring, and
R is hydrogen, F (fluorine), NH₂, SH, CN, COOH, SO₃H, CF₃, or NO₂.

2. The catalyst for a fuel cell of claim 1, wherein the crystalline carbon has a Raman spectrum intensity ratio of (1360) plane and (1580) plane, G/D((I(1580 cm⁻¹)/I(1360cm⁻¹)) of greater than or equal to about 0.7.

3. The catalyst for a fuel cell of claim 1, wherein the carrier has a specific surface area of about 50 m²/g to about 800 m²/g.

4. The catalyst for a fuel cell of claim 1, wherein the active metal is platinum, ruthenium, osmium, a platinum-ruthenium alloy, a platinum-osmium alloy, a platinum-palladium alloy, a platinum-M alloy (M is at least one transition element selected from Ga, Ti, V, Cr, Mn, Fe, Co, Ni, Cu, Zn, Sn, Mo, W, Rh, and Ru), or a combination thereof.

5. A method of preparing a catalyst for a fuel cell, comprising:
mixing a catalyst material containing crystalline carbon and an active metal or crystalline carbon, with an aromatic amine compound in a solvent to obtain a mixture;
adding NaNO₂ and HCl to the mixture;
agitating the mixture; and
drying the agitated product;

6. The method of claim 5, wherein the crystalline carbon is obtained by heat treating the carbon-based material at a temperature of about 1700° C. to about 3000° C.

7. The method of claim 5, wherein the aromatic amine compound is a compound represented by the following Chemical Formula 2: 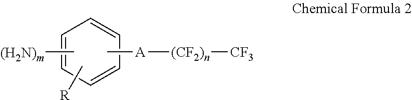
wherein;
A is a single bond or a heterocycle, provided when A is a single bond, n is 0 to 3, and when A is heterocycle, n is 0,
the heterocycle is an N-containing 5-membered ring or 6-membered ring;
m is 1 or 2, provided that when n is 3, m is 1; and
R is hydrogen, F (fluorine), NH₂, SH, CN, COOH, SO₃H, CF₃, or NO₂.

8. The method of claim 5, wherein the crystalline carbon and aromatic amine compound are mixed in a weight ratio of about 25:1 to about 1.24:1.

9. The method of claim 5, wherein the agitating is performed at about 50 rpm to about 500 rpm.

10. The method of claim 5, wherein the agitating is performed at about 0° C. to about 30° C.

11. An electrode for a fuel cell, comprising:
an electrode substrate; and
a catalyst layer disposed on the electrode substrate,
wherein the catalyst layer comprises the catalyst of claim 1.

12. A membrane-electrode assembly for a fuel cell; comprising
a cathode and an anode facing each other; and
a polymer electrolyte layer between the cathode and anode,
wherein at least one of the cathode and anode is the electrode of claim 11.

13. A fuel cell system, comprising:
at least one electricity generating element including the membrane-electrode assembly of claim 12 and a separator positioned at each side of the membrane-electrode assembly, and generating electricity through oxidation of a fuel and reduction of an oxidant;
a fuel supplier supplying the electricity generating element with a fuel, and
an oxidant supplier supplying the electricity generating element with the oxidant.
